(19) United States
(12) Patent Application Publication
(10) Pub. No.: US 2018/0236653 A1
(43) Pub. Date: Aug. 23, 2018

(54) TOOL CLAMPING ASSEMBLY

(71) Applicant: Jui-Chien KAO, TAICHUNG CITY (TW)

(72) Inventor: Jui-Chien KAO, TAICHUNG CITY (TW)

(21) Appl. No.: 15/439,153

(22) Filed: Feb. 22, 2017

(51) Int. Cl. B25H 3/00; B25H 3/04

(52) U.S. Cl. CPC B25H 3/006; B25H 3/04

(57) ABSTRACT

A tool clamping assembly has a track base and at least one clamping base. The track base has a bottom panel and two rails. The bottom panel is elongated and has a top surface. The two rails are disposed respectively on two sides of the top surface of the bottom panel, each one of the two rails has a sliding channel having an opening, and the two openings of the two sliding channels of the two rails face each other. The at least one clamping base is slidably mounted on the track base. Each one of the at least one clamping base has a sliding seat and two clamping tabs. The sliding seat is slidably mounted in the sliding channels of the rails. The two clamping tabs are formed on and protrude from the top side of the sliding seat at a spaced interval.

### BACKGROUND OF THE INVENTION

### 1. Field of the Invention

The present invention relates to a tool clamping assembly, and more particularly to an adjustable tool clamping assembly for clamping different tools.

### 2. Description of Related Art

With reference to FIG. 13, a conventional tool clamping assembly substantially comprises a base board 70 and multiple pairs of clamping tabs 72 formed on and protruding from the base board 70. A tool, such as a wrench or an extension rod, can be clamped between one of the pairs of the clamping tabs to fit with the use of sockets.

However, the clamping tabs of the conventional tool clamping assembly are integrally formed on the base board at fixed positions and are not moveable to adjust the positions of the clamping tabs. Therefore, the conventional tool clamping assembly can only be applied to clamp specific tools in particular sizes and shapes and is not versatile in use.

To overcome the shortcomings of the conventional tool clamping assembly, the present invention provides an adjustable tool clamping assembly to mitigate or obviate the aforementioned problems.

### SUMMARY OF THE INVENTION

The present invention relates to a tool clamping assembly that is adjustable to clamp different tools in different sizes and shapes.

The tool clamping assembly has a track base and at least one clamping base. The track base has a bottom panel and two rails. The bottom panel is elongated and has a top surface. The two rails are disposed respectively on two sides of the top surface of the bottom panel, each one of the two rails has a sliding channel having an opening, and the two openings of the two sliding channels of the two rails face each other. The at least one clamping base is slidably mounted on the track base. Each one of the at least one clamping base has a sliding seat and two clamping tabs. The sliding seat is slidably mounted in the sliding channels of the rails. The two clamping tabs are formed on and protrude from the top side of the sliding seat at a spaced interval.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a tool clamping assembly in accordance with the present invention;

FIG. 2 is an enlarged exploded perspective view of the tool clamping assembly in FIG. 1;

FIG. 3 is an enlarged cross sectional end view of the tool clamping assembly in FIG. 1;

FIG. 4 is a perspective view of a second embodiment of a tool clamping assembly in accordance with the present invention;

FIG. 5 is an enlarged exploded perspective view of the tool clamping assembly in FIG. 1;

FIG. 6 is an enlarged cross sectional end view of the tool clamping assembly in FIG. 1;

FIG. 7 is a perspective view of a third embodiment of a tool clamping assembly in accordance with the present invention;

FIG. 8 is an enlarged exploded perspective view of the tool clamping assembly in FIG. 1;

FIG. 9 is an enlarged cross sectional end view of the tool clamping assembly in FIG. 1;

FIG. 10 is an operational perspective view of the tool clamping assembly in accordance with the present invention;

FIG. 11 is an operational end view in partial section of the tool clamping assembly in FIG. 10;

FIG. 12 is another operational perspective view of the tool clamping assembly in accordance with the present invention; and

FIG. 13 is a perspective view of a conventional tool clamping assembly.

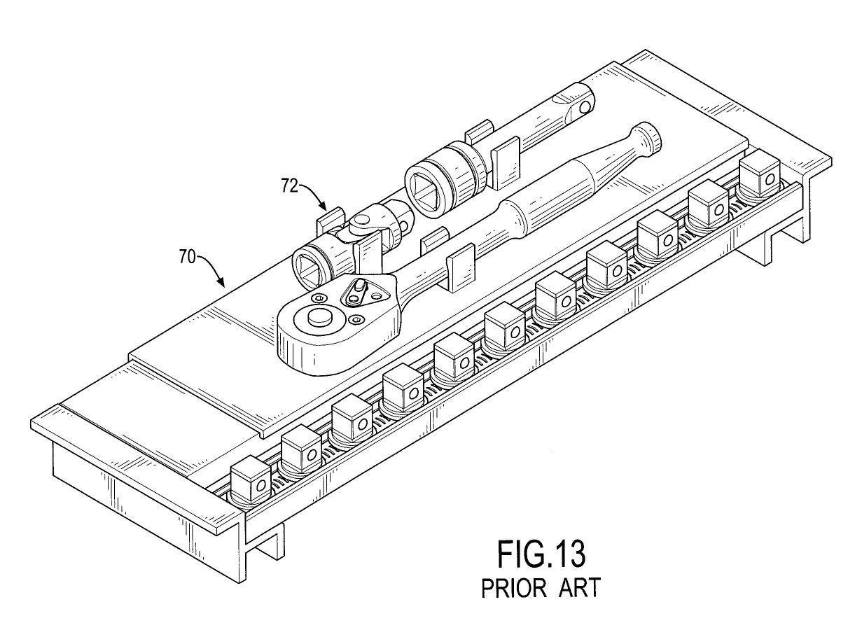

### DETAILED DESCRIPTION OF PREFERRED EMBODIMENT

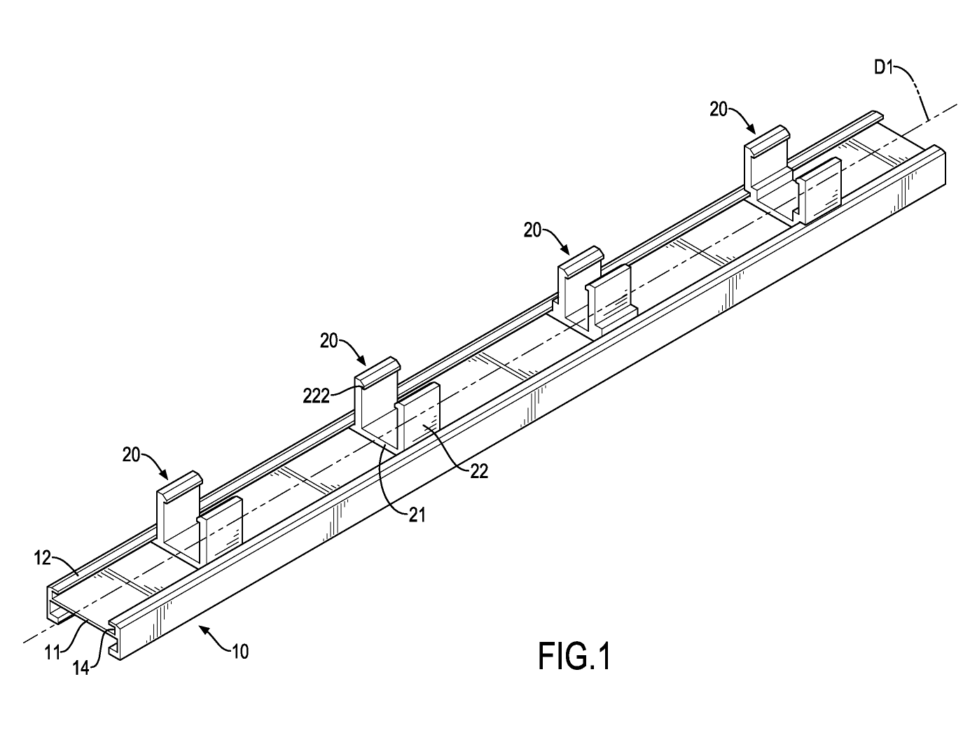

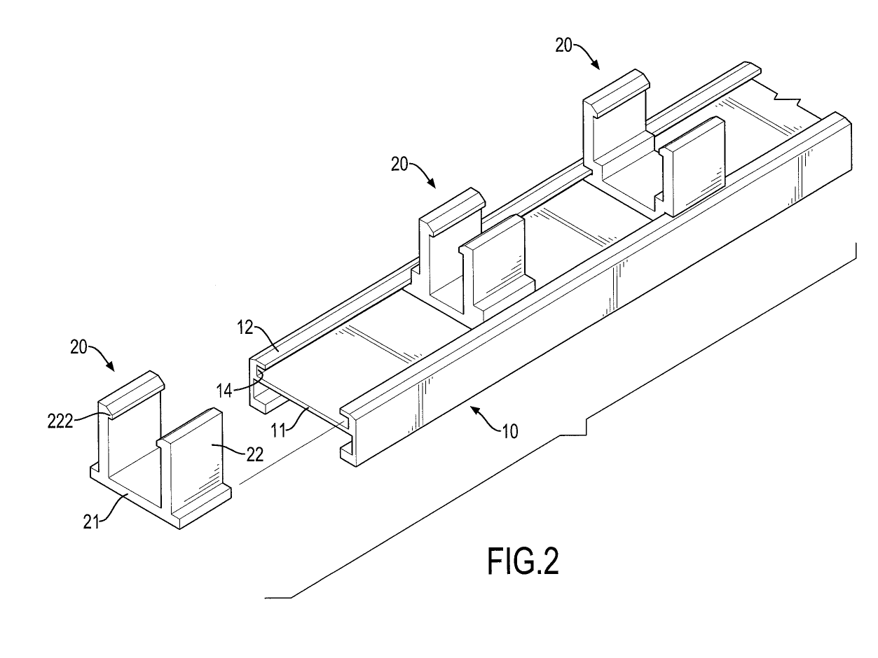

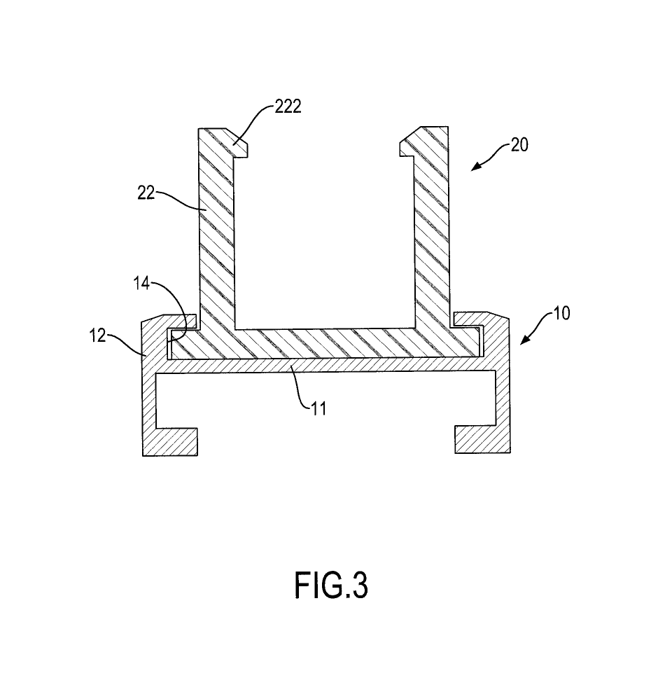

With reference to FIGS. 1 to 3, a tool clamping assembly in accordance with the present invention comprises a track base 10 and at least one clamping base 20.

The track base 10 is elongated, is made of metal, and is preferably an aluminum extrusion. The track base 10 comprises a bottom panel 11 and two rails 12. The bottom panel 11 is elongated and has a top surface. The two rails 12 are respectively formed on and protrude from two sides of the top surface of the bottom panel 11. Each rail 12 has a sliding channel 14. Each one of the two sliding channels 14 has an opening, and the two openings of the two sliding channels 14 face each other.

The at least one clamping base 20 is slidably mounted on the track base 10, and each one of the at least one clamping base 20 has a sliding seat 21 and two clamping tabs 22. The sliding seat 21 may be square in shape and is slidably mounted in the sliding channels 14 in the rails 12. The sliding seat 21 has a bottom side and a top side. The bottom side of the sliding seat 21 may abut the top surface of the bottom panel 11. The two clamping tabs 22 are formed on and protrude from the top side of the sliding seat 21 at a spaced interval. Each of the two clamping tabs 22 has a free end provided with a hook segment, and the two hook segments of the two clamping tabs 22 extend toward each other.

Because the at least one clamping base 20 is slidably mounted on the track base 10. The position of the at least one clamping base 20 may be adjusted to clamp different tools in different sizes and shapes.

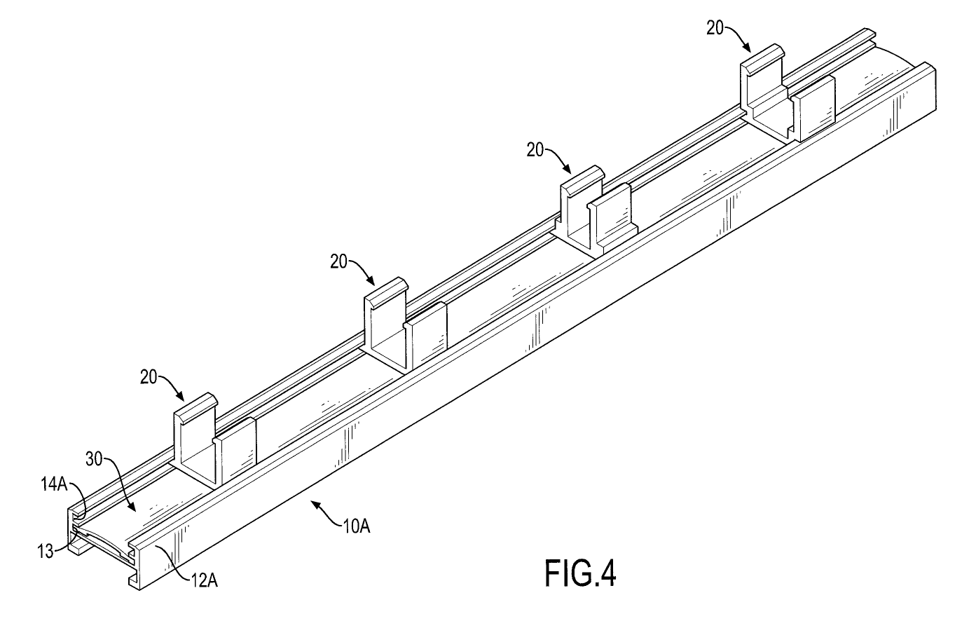

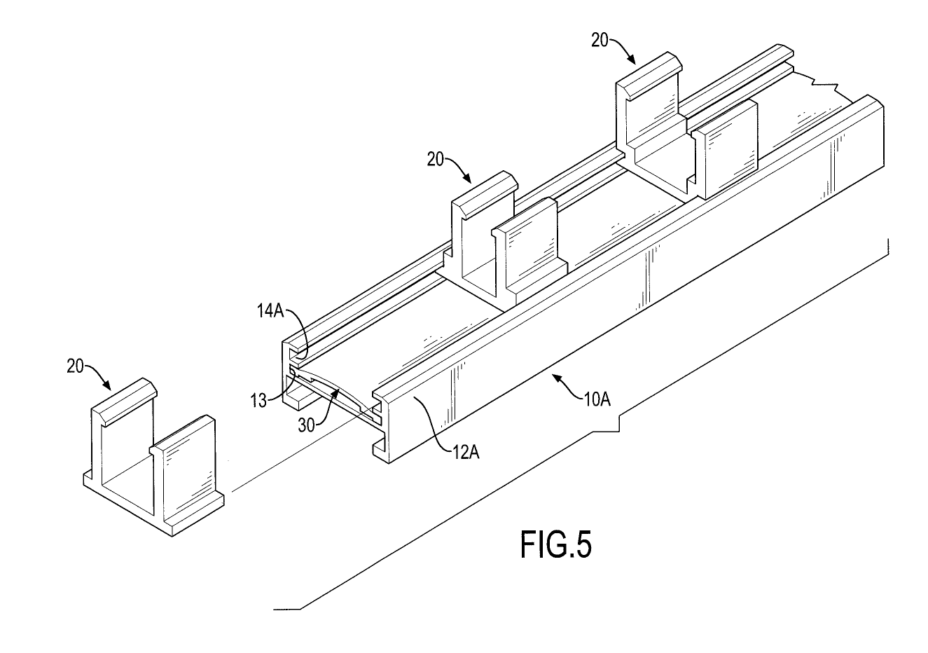

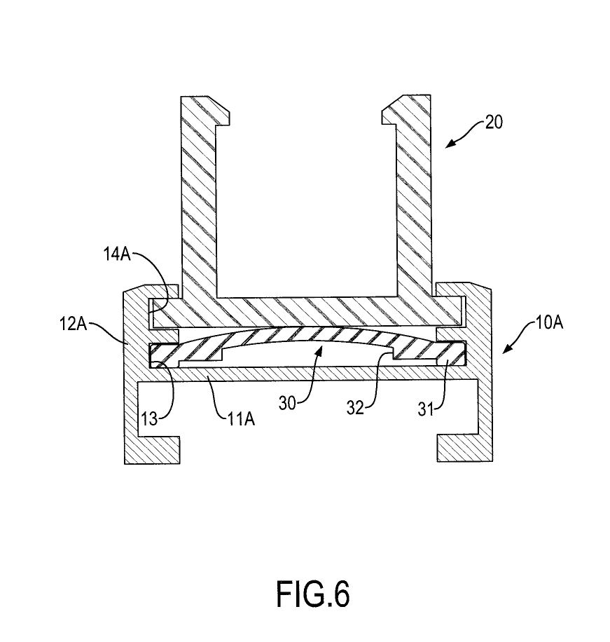

With reference to FIGS. 4 to 6, in a second embodiment, each rail 12A further has a positioning channel 13 located below the sliding channel 14A of the rail 12A. Each positioning channel 13 has an opening, and the two openings of the two positioning channels 13 of the two rails 12A face each other.

In addition, the tool clamping assembly further comprises a positioning board 30. The positioning board 30 is resilient, is mounted in the positioning channels 13 in the rails 12A of the track base 10A, and has two long opposite sides, two free ends, a middle, a top surface, a bottom surface, two rail bars 31 and a recess 32. The positioning board 30 is convex from the two long opposite sides to the middle of the positioning board 30. The two rail bars 31 are formed on and protrude outwardly from the bottom surface of the positioning board 30 respectively at the two long opposite sides of the positioning board 30 and are mounted respectively in the positioning channels 13 of the rails 12A. The recess 32 is formed in the bottom surface of the positioning board 30 at the middle of the positioning board 30 between the free ends of the positioning board 30, and is parallel with the two long opposite sides of the positioning board 30 to define a space between the middle of the positioning board 30 and the top surface of the bottom panel 11A. The space allows the positioning board 30 to be deformed relative to the track base 10A. Alternatively, the positioning board 30 may be formed with the track base 10A as a single piece.

With such an arrangement, the top surface of the positioning board 30 can abut the sliding seat 21 of each clamping base 20. With the curved and resilient positioning board 30, a push force can be applied to the at least one clamping base 20 to hold the at least one clamping base 20 in position relative to the track base 10A.

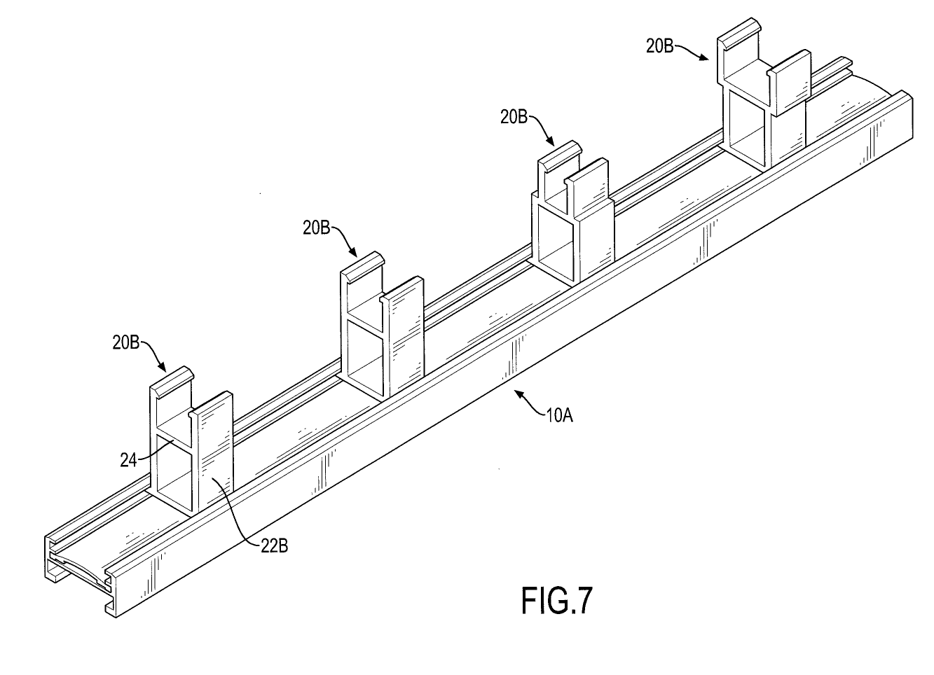

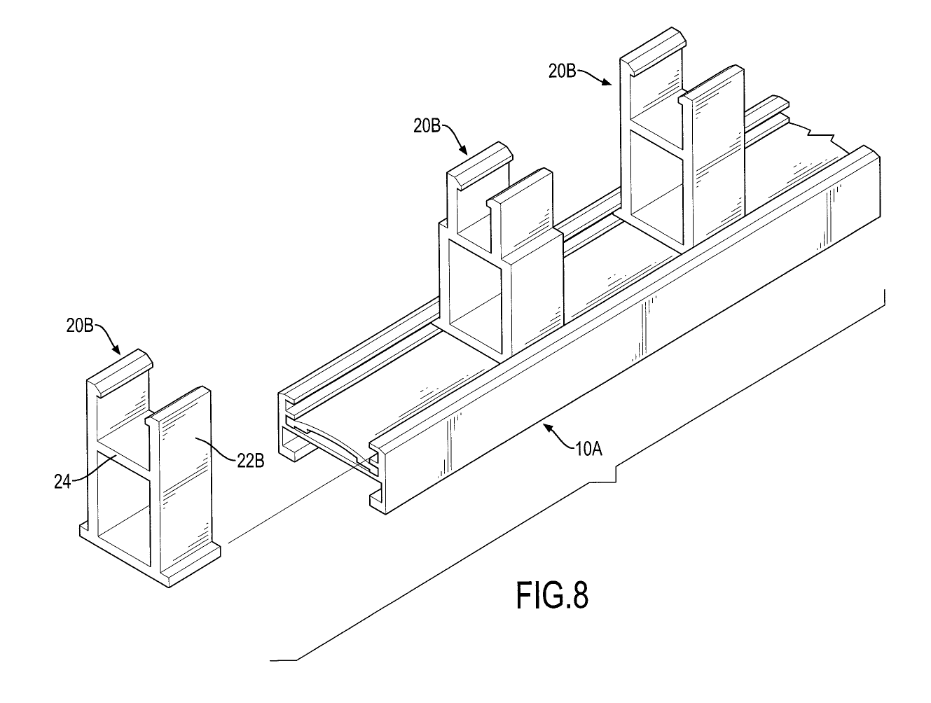

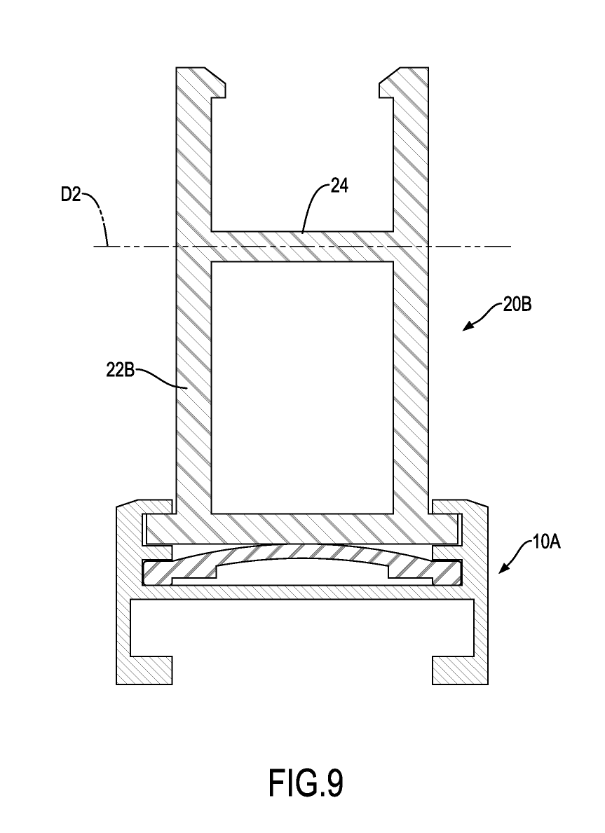

With reference to FIGS. 7 to 9, in a third embodiment, each one of the at least one clamping base 20B further comprises a connection tab 24 having two ends respectively connected with the clamping tabs 22B of the clamping base 20B. With the arrangement of the connection tab 24, the structural strength of each clamping base 20B can be enhanced, and the connection tab 24 can provide a supporting effect to the tool clamped between the clamping tabs 22B.

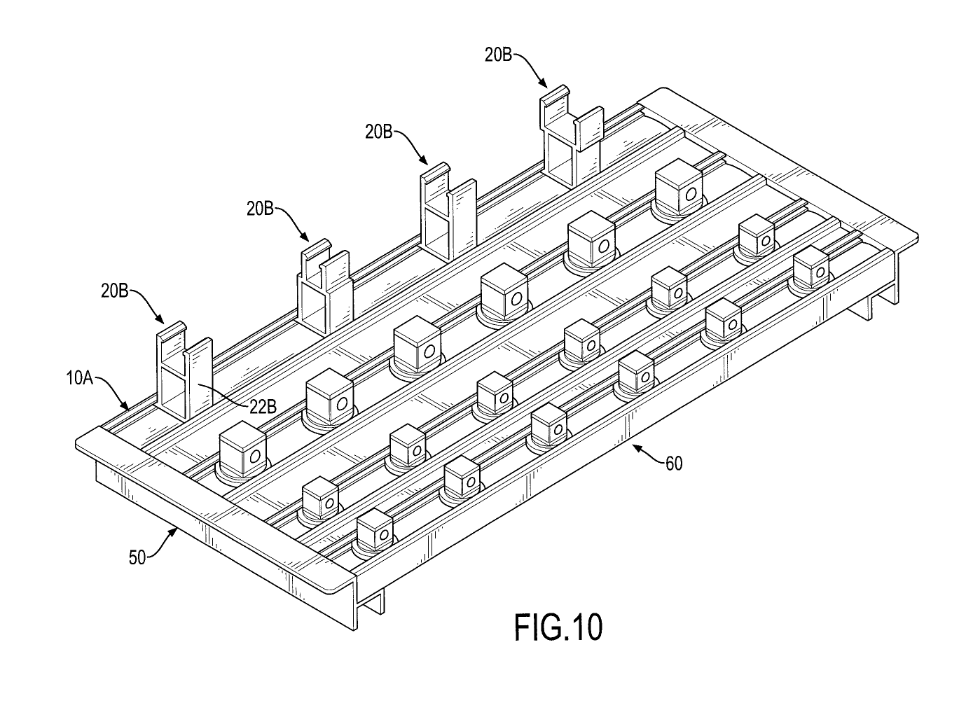

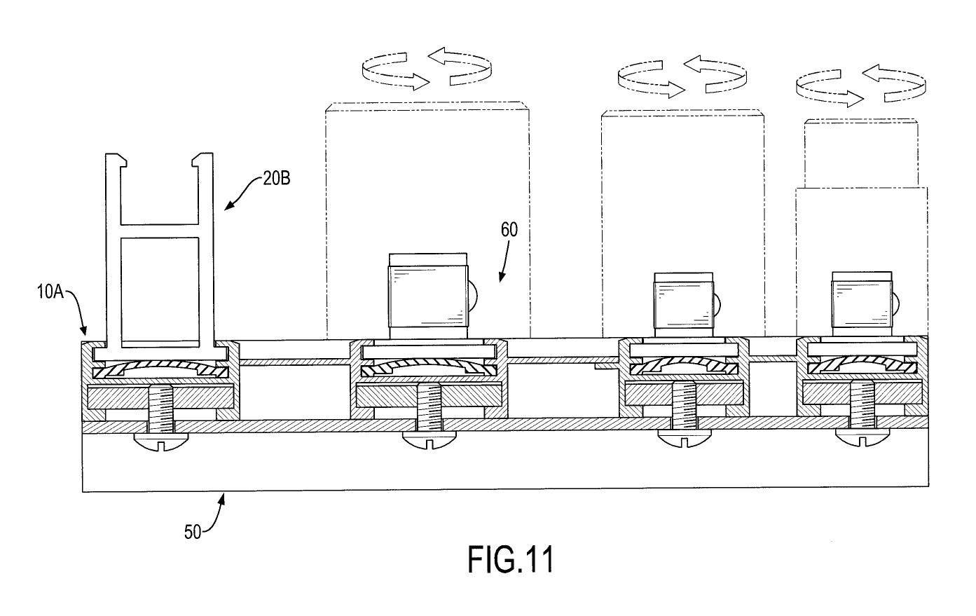

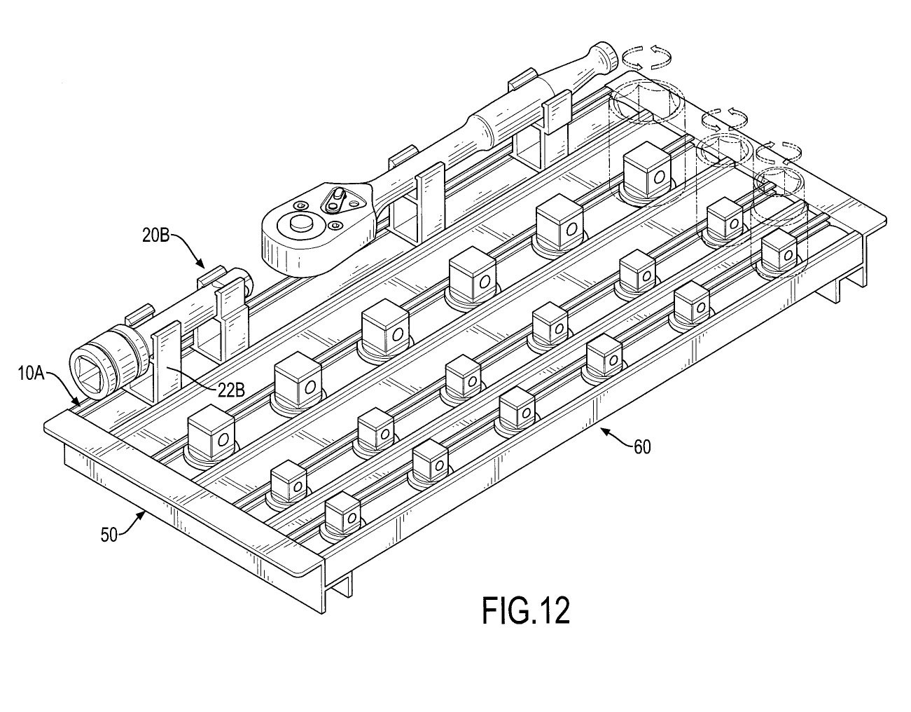

With reference to FIGS. 10 to 12, in use, the tool clamping assembly can be connected with socket holding frames 60 with two connection frames 50. Accordingly, sockets can be held on the socket holding frames 60, and tools, such as a wrench or an extension rod, can be clamped between the clamping tabs 22B on the clamping bases 20B. Accordingly, the tool clamping assembly can be connected with the socket holding frames 60 to form a tool assembly, such that a user can take and use the sockets and tools held on the tool assembly conveniently. Because the clamping bases 20B are slidable relative to the track base 10A, the positions of the clamping bases 20B can be adjusted to desired positions to clamp different tools in different sizes and shapes. Thus, the tool clamping assembly in accordance with the present invention is versatile in use.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A tool clamping assembly comprising:
a track base being an elongated seat extending along a first direction, and having
a bottom panel being elongated and having a top surface;
two rails disposed respectively on two sides of the top surface of the bottom panel, each one of the two rails having a sliding channel having an opening, and the two openings of the two sliding channels of the two rails facing each other;
at least one clamping base slidably mounted on the track base, and each one of the at least one clamping base having
a sliding seat slidably mounted in the sliding channels of the rails and having a top side; and
two clamping tabs formed on and protruding from the top side of the sliding seat at a spaced interval and extending along the first direction; and
a connection tab having two ends along a second direction that is perpendicular to the first direction and respectively connected with the clamping tabs of the clamping base, wherein
each one of the two clamping tabs of each one of the at least one clamping base has a free end provided with a hook segment formed on the free end and extending along the first direction, and the two hook segments of the two clamping tabs extend toward each other.

2. The tool clamping assembly as claimed in claim 1 further comprising a positioning board disposed on the track base and having two long opposite sides and a middle, wherein
the positioning board is convex from the long opposite sides to the middle of the positioning board.

3. The tool clamping assembly as claimed in claim 2, wherein each rail of the track base further has a positioning channel located below the sliding channel of the rail and having an opening;
the openings of the positioning channels of the two rails face each other;
the positioning board is mounted in the positioning channels in the rails of the track base and further comprises
a bottom surface;
two rail bars formed on and protruding outwardly from the bottom surface of the positioning board respectively at the two long opposite sides of the positioning board and mounted respectively in the positioning channels of the rails of the track base; and
a recess formed in the bottom surface of the positioning board at the middle of the positioning board, the recess being parallel with the long opposite sides of the positioning board to form a space between the middle of the positioning board and the top surface of the bottom panel.

4-9. (canceled)
